(19) United States
(12) Patent Application Publication
(10) Pub. No.: US 2021/0217076 A1
(43) Pub. Date: Jul. 15, 2021

(54) Interactive Kiosk System

(71) Applicant: Analytical Design Solutions, Inc., York, PA (US)

(72) Inventors: James Scott Kruper, York, PA (US); Bryan Bosley, Lancaster, PA (US)

(21) Appl. No.: 17/145,610

(22) Filed: Jan. 11, 2021

Related U.S. Application Data
(60) Provisional application No. 62/959,588, filed on Jan. 10, 2020.

(51) Int. Cl. G06Q 30/06; G06K 7/14; G06K 7/10; H04W 12/06; G06F 3/0488; H04L 29/08

(52) U.S. Cl. CPC G06Q 30/0641; G06K 7/1417; G06K 7/1095; G06K 7/10297; G06Q 20/18; G06F 3/0488; H04L 67/02; G06Q 30/0633; H04W 12/06

(57) ABSTRACT

An interactive kiosk system is disclosed that enables remote control of a kiosk via a user's mobile wireless device such as a smartphone or tablet. The mobile wireless device obtains a URL of the kiosk and wirelessly connects with the kiosk. The kiosk downloads a client application to the mobile wireless device that enables the wireless mobile device to be used as a remote input device that controls the kiosk. The client application may connect to a network server that relays input device events received from the mobile wireless device to the kiosk. The server enables multiple users to simultaneously control different network kiosks connected to the server.

### RELATED APPLICATION

This application claims priority to and the benefit of the filing date of U.S. provisional application 62/959,588 filed Jan. 10, 2020 at attorney docket no. 1-2692-P and entitled “Client/Server Kiosk System”, which provisional application was pending on the filing date of this application and which priority provisional application is incorporated by reference as if fully set forth herein.

### FIELD OF THE DISCLOSURE

The disclosure relates generally to interactive kiosks, and in particular to an interactive kiosk system and related method that enables users to interact with a kiosk without physical contact with the kiosk.

### BACKGROUND OF THE DISCLOSURE

Interactive kiosks are unmanned, standalone computer systems that provide information or services to a user of the kiosk in response to user input. Interactive kiosks are used, as a non-limiting example, in restaurants. A kiosk may be placed on each restaurant table and are networked together and communicate with a remote server, the server perhaps also on the restaurant premises or located in the cloud. The kiosk includes a touchscreen that enables a customer to interact with the kiosk to view the restaurant menu, place an order, and pay the bill.

Kiosk users are concerned that interactions with kiosks be sanitary and not spread infection through touch contact with kiosk screens, keyboards, or other kiosk controls.

Thus there is a need for interactive kiosk systems that enable users to interact with the kiosk without the need to touch the kiosk. The interaction with the kiosk should not require the user to take any special steps or install dedicated software prior to using the kiosk. The kiosk system furthermore should be ADA compliant and provide access to interactive kiosks to more users.

### SUMMARY OF THE DISCLOSURE

Disclosed is an interactive kiosk system and method that allows a user to interact with a kiosk without requiring physical contact with the kiosk. The user does not have to take any special steps or install dedicated kiosk control software prior to using the kiosk. Embodiments of the disclosed interactive kiosk system are ADA compliant and provide access to the kiosk to more users.

Smartphones, tablets, and other mobile devices have become ubiquitous in today's society. It is estimated that about 85% of the US adult population in 2020 has a smartphone, that is, a wireless mobile computing device having more advanced technological capability than a basic “flip phone”. A smartphone includes a touchscreen and web browser software that displays web pages and enables a user to interact through the web page with a remote web server using the touchscreen. Modern smartphones also typically include the ability to communicate through short-range wireless communications protocols such as Bluetooth or NFC, and have cameras that can obtain information from scanning and decoding QR codes.

The disclosed interactive kiosk system utilizes a user's mobile wireless device (typically embodied as a battery-powered smartphone or tablet that is easily portable) to provide a dedicated user interface spaced from the kiosk for interacting with the kiosk. The user interface functions as an input device for the kiosk that transmits data representing user interface touch/mouse events to the kiosk for execution on the kiosk. The user interface may also be used as an output device to communicate messages (for example, instructions, advertisements, error messages, or the like) or user forms (for example, a form to authenticate the connection between the user and the kiosk).

The dedicated user interface may be a GUI visual touchscreen interface or may be an audio interface for those with visual impairment.

In embodiments of the disclosed kiosk system the web browser on the mobile wireless device runs the client application software that provides the user's dedicated kiosk interface. The client application serializes the user's touch/mouse events and transmits the serialized touch/mouse events to the kiosk.

In embodiments of the interactive kiosk system the client application transmits the serialized touch/mouse events directly to the kiosk via a wireless network connection. In other embodiments the client application transmits the serialized touch/mouse events to an intermediary device via a wired network connection and the intermediary device relays the serialize touch/mouse events to the kiosk via a wired or wireless network connection. The intermediary device may be a network server connected to a number of different kiosks, transmitting data received from a client application to the appropriate kiosk. In yet other embodiments the intermediary device may form part of one kiosk that functions as a network server to other kiosks on the network.

Network connections in the interactive kiosk system may use the HTTP/HTTPS protocol control. The kiosk and server (if present) may function as a web server to receive data transmitted from the client application. The web server on the intermediary device enables the simultaneous control of multiple kiosks connected to the web server by multiple users and enables access to the intermediary device by the user via a URL.

The URL of the intermediary device may be supplied to the user's mobile wireless device in different ways. The user may scan a QR code encoding the URL that is displayed by the kiosk. The user may receive wireless near field communications (for example, BLUETOOTH or NFC communications) from the kiosk transmitting the URL. Or the kiosk may display the URL and the user manually types the URL in the address bar of the user's mobile device web browser.

In some embodiments of the disclosed interactive kiosk system the user must authenticate the network connection before being able to control the kiosk (in secure environments the system architect may choose not to authenticate network connections). For example, the kiosk may display a security code or authentication code. In connecting with the kiosk, a form is transmitted to the user's mobile device for the user to submit the code. Other authentication schemes are known in the art and can be also be adapted for use with the disclosed interactive kiosk system.

In embodiments of the disclosed interactive kiosk system the kiosk or the server downloads the client application to the user's mobile wireless device. The client application is typically downloaded as a web page containing the client application computer code (for example, Javascript code). In this way the user does not have to pre-install the client application on the mobile wireless device.

The disclosed interactive kiosk system has a number of advantages. By using the user's own mobile wireless device as a remote user input device for the kiosk, the exposure risk is minimized. Furthermore, the wireless remote connection with the user enables the user to be conveniently spaced from the kiosk during use of the kiosk, enhancing accessibility to the kiosk.

Other objects and features of the disclosure will become apparent as the description proceeds, especially when taken in conjunction with the accompanying drawing sheets illustrating one or more illustrative embodiments.

### BRIEF DESCRIPTION OF THE DRAWINGS

FIG. 1 is a schematic representation of a first embodiment interactive kiosk system in which a user's smartphone controls the kiosk in accordance with this disclosure.

FIG. 2 is a schematic drawing of the kiosk used in the interactive kiosk system shown in FIG. 1.

FIG. 3 is a schematic drawing of the applications in the memory of the kiosk shown in FIG. 2 enabling remote control of the kiosk.

FIG. 4 is a schematic drawing of the smartphone used in the interactive kiosk system shown in FIG. 1.

FIG. 5 is a schematic drawing of the applications in the memory of the smartphone shown in FIG. 4 enabling the smartphone to control the kiosk.

FIG. 6 illustrates a method for remote control of the kiosk by the smartphone using the interactive kiosk system shown in FIG. 1.

FIG. 7 illustrates alternative methods for obtaining the kiosk URL to initiate the step of connecting the smartphone and kiosk shown in FIG. 6.

FIGS. 8-10 further illustrate the alternative methods shown in FIG. 7 for obtaining the kiosk URL.

FIG. 11 illustrates use of the authentication code to authenticate the network connection between the smartphone and the kiosk used in the interactive kiosk system shown in FIG. 1.

FIG. 12 illustrates use of the client application on the smartphone to control the kiosk using the interactive kiosk system shown in FIG. 1.

FIG. 14 illustrates a portion of a second embodiment interactive kiosk system in accordance with this disclosure.

FIG. 15 is a schematic drawing of a server used in the interactive kiosk system shown in FIG. 14.

FIG. 16 is a schematic drawing of the applications in the memory of the server shown in FIG. 15 enabling the server to transmit data between the smartphone and the kiosk shown in FIG. 14.

FIG. 17 is a view of the second embodiment interactive kiosk system shown partially in FIG. 14.

FIG. 18 a method for remote control of the kiosk by the smartphone using the interactive kiosk system shown in FIG. 17.

FIG. 19 is a view of a third embodiment interactive kiosk system in accordance with this disclosure.

### DETAILED DESCRIPTION

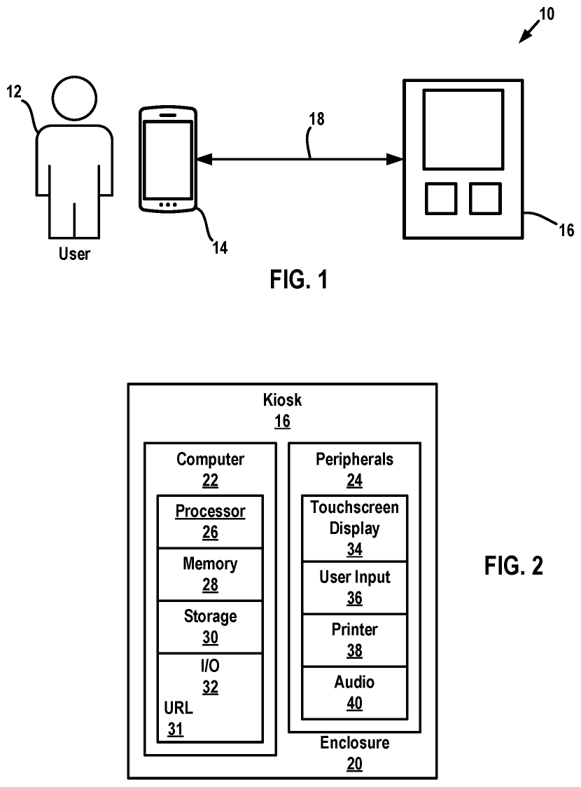

FIG. 1 illustrates operation of a first embodiment interactive kiosk system 10 in accordance with this disclosure. A user 12 having a mobile wireless device (a smartphone 14) uses the smartphone to operate a kiosk 16. The smartphone and the kiosk are connected by a wireless connection represented by the double-arrowed line 18 that enables the user to operate the kiosk via the smartphone without touching or otherwise making physical contact with the kiosk. In the illustrated embodiment the wireless connection transmits data between the smartphone 14 and the kiosk 16 using the HTTPS encrypted protocol.

FIG. 2 schematically illustrates the major components of the kiosk 16. The kiosk includes an enclosure 20 housing a computer 22 and computer peripherals 24. The computer controls operation of the kiosk and includes a processor 26, high speed memory 28 connected to the processor, non-volatile storage 30 which may one or more hard drives or solid-state drives (SSDs), and a wireless input/output (I/O) port 32 that enables wireless WIFI communications with the computer. The I/O port is associated with a URL 31 assigned to the kiosk for use in establishing the wireless connection 18.

The computer peripherals 24 include a touchscreen display 34, additional user input hardware 36, a printer 38, and audio hardware 40.

The touchscreen display 34 not only functions as an output display but also enables a user to control the kiosk entering mouse/touch commands using a conventional touch user interface. The touchscreen display receives touches and multi-finger gestures from the user and displays a virtual keyboard whenever alphanumeric input is requested from the user. The additional user input hardware 36 includes a keypad with physical buttons that functions as a secondary user input. The printer 38 prints receipts, coupons, and the like. The audio hardware 40 includes a speaker and microphone that that provides audio input and output.

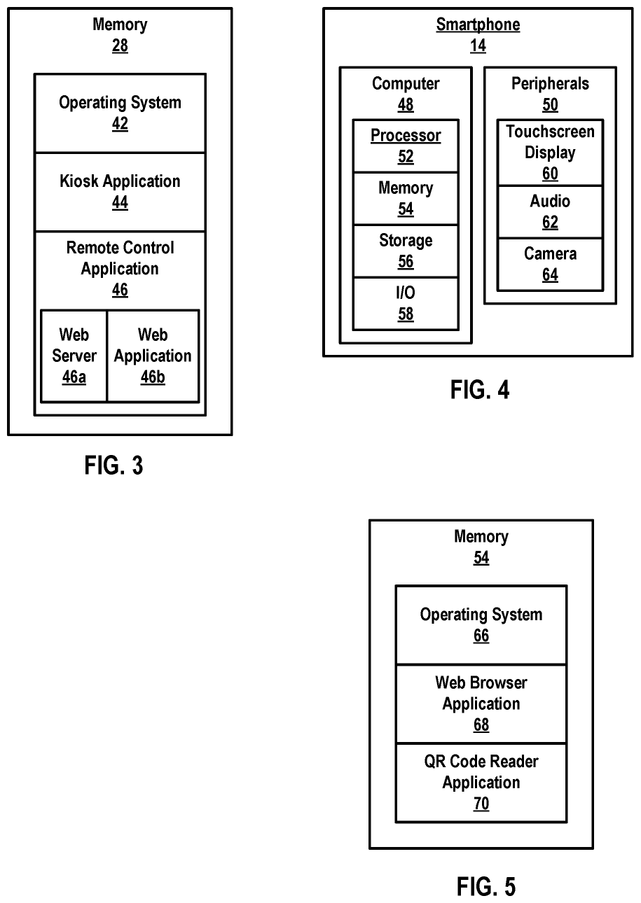

The processor 26 runs software applications stored in the high speed memory 28. The software applications include the kiosk operating system 42, a kiosk application 44, and a remote control application 46. See FIG. 3.

The kiosk operating system 42 may be a Microsoft Windows operating system, a Linux operating system, a Unix operating system, an Apple macOS operating system, or the like. The operating system is system-level software that manages and interacts with the computer hardware and provides common application services and interfaces for application programs.

The kiosk application 44 ensures that the kiosk is secured and always running, prevents misuse, and allows the kiosk to operate unattended (for example, by displaying a “welcome screen” or an “attraction screen” while the kiosk is not interacting with a user). The kiosk application protects software applications running on the kiosk computer by blocking users from reaching the operating system, changing systems settings, or overwriting the kiosk memory or non-volatile storage. The kiosk application interacts with the kiosk user via the touchscreen display 34, additional user input hardware 36, and the audio hardware 40, and generates the output displayed on the touchscreen device. The kiosk application typically enables remote management of the kiosk via the internet or through a local network. The kiosk application may be, for example, KIOWARE™ kiosk application software available from KioWare, York, Pa.

The remote control application 46 enables the user to interact with the kiosk 16 without requiring physical contact with the kiosk. The remote control software application 46 receives data from the user's mobile wireless device 14 through the computer WIFI port 32 and also transmits data to the wireless device 14 through the computer WIFI port 32. The data received from the mobile wireless device to control the kiosk serves as user input that is input to the kiosk application 44 by the remote control application 46. In the illustrated embodiment the smartphone 14 is essentially used as an input device only and the user views the kiosk display 34 as the kiosk output device.

The remote control software application 46 in the illustrated embodiment includes two major subcomponents: a web server application 46a and a web application 46b.

The web server 46a processes incoming and outgoing HTTPS network communications. Examples of available web server applications include the Apache Software Foundation APACHE™ and TOMCAT™ servers, F5 Networks Inc. NGINX™ server, LITESPEED™ server, Microsoft IIS™ server, WSGI compatible servers such as WAITRESS™ and GUNICORN™, and ASGI compatible servers such as UVICORN™ and HYPERCORN™.

The web application 46b receives data from the web server 46a and transmits data through the web server, and may also access the operating system 42. Web application frameworks to create the web application are available in many computer languages, including EXPRESS™ (Javascript), FLASK™ (Python), RUBY ON RAILS™ (Ruby), LARAVEL™ (PHP), and Microsoft ASP.NET (C#).

The user's smartphone 14 is illustrated schematically in FIG. 4. The smartphone is conventional and includes a computer and computer peripherals 50. The computer includes a processor 52, high speed memory 54, non-volatile memory 56, and wireless input/output (I/O) 58. The wireless I/O enables the smartphone to transfer data via industry-standard protocols including WIFI, Bluetooth, and NFC.

The computer peripherals 50 include a touchscreen display 60, audio hardware 62, and one or more cameras 64. The audio hardware includes one or more speakers and a microphone.

The smartphone computer processor 52 runs software applications stored in the high speed memory 54. The software applications include the smartphone operating system 66, which may be the Apple IOS operating system, the Google Android operating system, or the like. The smartphone typically includes software applications such as a web browser application 68 (for example, Apple Safari, Google Chrome, Mozilla Firefox, or the like), and a QR code reader application 70 that uses the smartphone camera to scan and then decode QR codes. See FIG. 4.

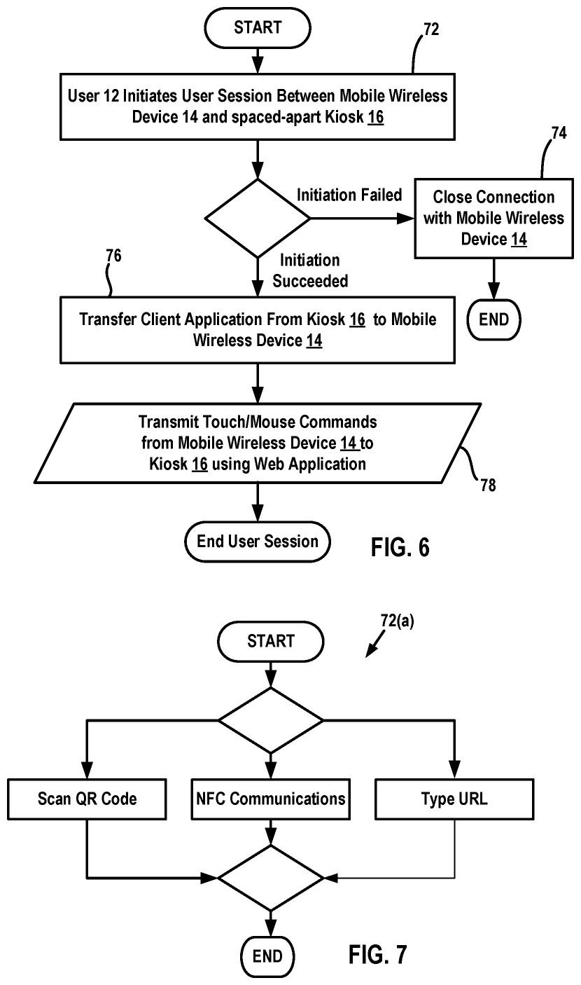

FIG. 6 illustrates operation of the interactive kiosk system 10. In the first step 72, the user initiates a user session utilizing a wireless connection between the user's smartphone 14 and the kiosk 16 spaced from the smartphone. Essentially initiating the user session includes the steps of connecting the smartphone to the kiosk URL, and the user authenticating the connection.

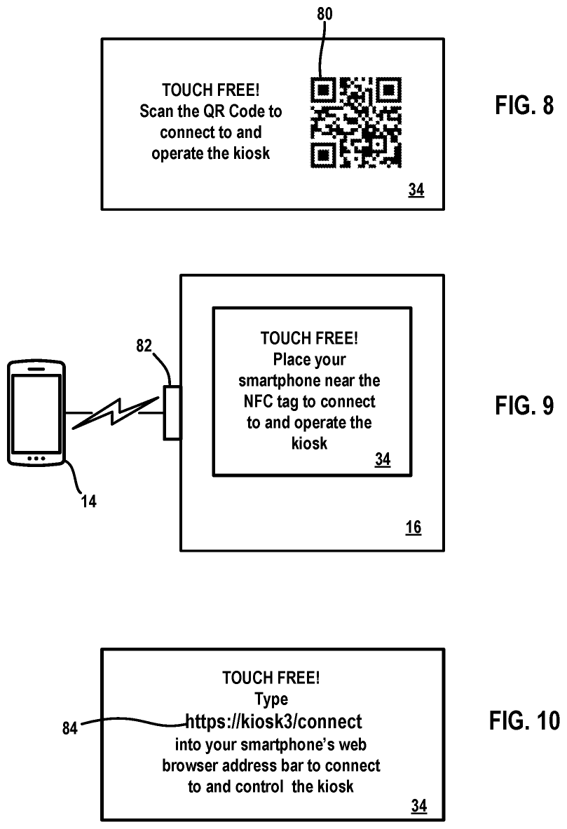

There are a number of ways the user can connect the smartphone 14 to the kiosk URL 31 to initiate the user session. These are shown as step 72 (a) in FIG. 7 and include (but are not necessarily limited to): (a) scanning a QR code displayed by the kiosk, (b) using NFC communications transmitted from the kiosk to the smartphone, and (c) typing in the kiosk URL in the smartphone web browser address bar. See FIGS. 8-10.

In FIG. 8, the kiosk touchscreen 34 displays a QR code 80 that encodes the kiosk's URL 31. Scanning the QR code with the smartphone QR code reader application 70 opens the smartphone web browser application 68 and automatically connects the browser with the URL.

In FIG. 9, the kiosk includes an NFC tag 82 that broadcasts the kiosk URL 31. Scanning the NFC tag with the smartphone 12 opens the smartphone web browser application 68 and automatically connects the browser with the URL.

In FIG. 10, the kiosk display 34 displays the kiosk URL 31. The user manually opens the smartphone web browser 68 and types the URL in the browser address bar to connect the browser with the URL.

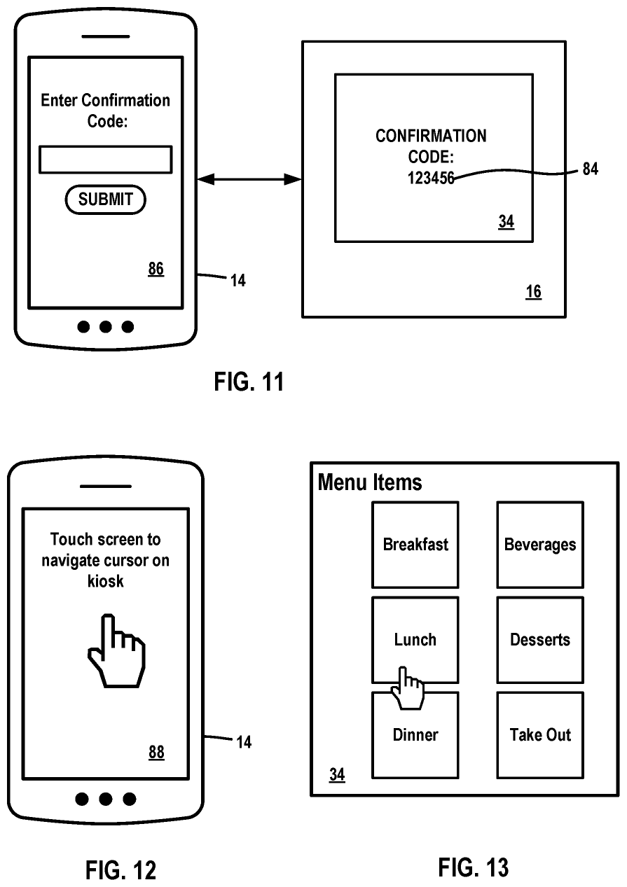

After connecting the user's smartphone 14 with the kiosk 16, the user 12 is asked to authenticate the connection as shown in step 72(b). The kiosk remote control application 46 generates a authentication code 84 (in this embodiment, a six-digit number) that is displayed on the kiosk touchscreen 34. The kiosk remote control application also transmits a web form 86 to the user's web browser for the user to submit the authentication code back to the kiosk for authentication. See FIG. 11. The kiosk may require that the authentication code be entered within a predefined time span (for example, two minutes) to authenticate the connection.

If the user fails to authenticate the connection, initiation of the connection is deemed to have failed and the kiosk 16 closes the connection with the smartphone as shown in step 74. and the. The kiosk may optionally display an error message, may transmit an error message to the user's web browser, or may fail silently.

If the user authenticates the connection, the initiation of the connection is confirmed and in step 76 the kiosk remote control application 46 downloads a web page to the smartphone 14 that includes client application code to provide the needed functionality of a client application 88 (see FIG. 12) without the need for the user to pre-install an app prior to use.

Mobile web browsers have efficient Javascript engines and so the client application code in the illustrated embodiment is Javascript code. In addition to “just plain Javascript”, Javascript application frameworks useful for developing the client application include REACT™, VUE™, ANGULAR™, and BACKBONE.JS™.

The client application 88 forces the smartphone web browser to open full screen and displays instructions on how to interact with the kiosk and any other information that the kiosk owner may wish to initially present to the user (for example, branding, hours of operation, promotions, etc.). The client application is then ready to receive user interactions to be passed to the kiosk remote control application 46. See FIG. 12.

In step 78, the user 12 controls the kiosk 16 through the client application 88. The client application collects from the smartphone operating system user touch/mouse events (typically using event listeners), serializes the touch/mouse events, and transmits the serialized touch/mouse events to the kiosk web server 46a. The kiosk web application 46b translates the serialized touch/mouse events into corresponding kiosk operating system touch/mouse events that are processed by the kiosk application 44 as actual kiosk touch/mouse events as if the events were actually executed on the kiosk touchscreen.

FIG. 13 illustrates the kiosk display 34 while the kiosk is being controlled by the smartphone client application 88. In this embodiment the user views the kiosk display screen to confirm the position the cursor on the kiosk while using the client application to move the cursor.

If the user does not generate a smartphone touch/mouse event within a period of time, the kiosk web application 46b or the client application 88 can close the connection between the smartphone and the kiosk. The connection between the smartphone and the kiosk can also close by user command issued through the client application 88.

Instead of allowing the user to directly close the network connection between the smartphone 12 and the kiosk 16 by command or by nonuse within the allotted time span, the kiosk web application 46b can redirect the smartphone web browser to another URL to display advertisements, provide coupons, enable user registration, or other content or user actions that the kiosk owner might choose to present to the user.

In other embodiments of the client application 88, the client application can display a user interface corresponding to the kiosk display, enabling the user to operate the kiosk without having to view the kiosk display itself.

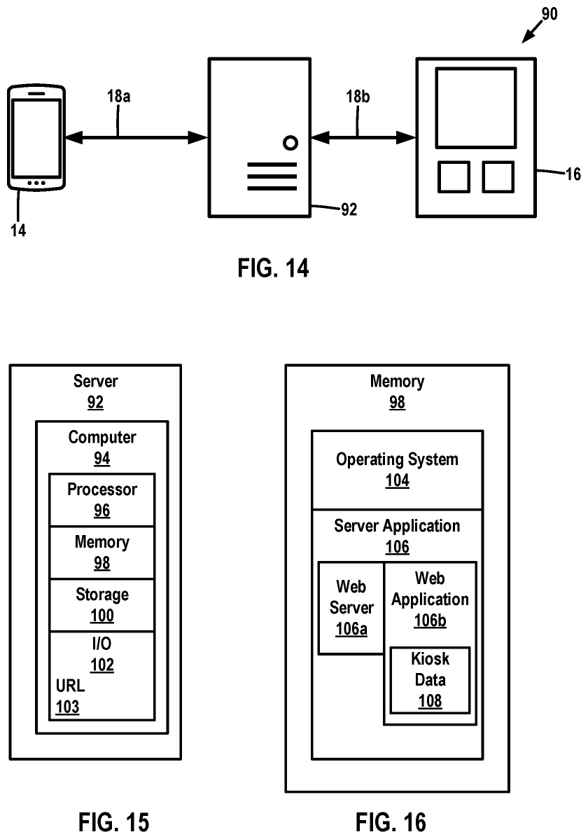

FIG. 14 illustrates a portion of a second embodiment interactive kiosk system 90 in accordance with this disclosure. In this embodiment the user's mobile wireless device 12 communicates with the kiosk 16 through an intermediary server 92. A wireless network connection 18a connects the smartphone 12 and the server 92, and a wired or wireless network connection 18b connects the server and the kiosk. The network connections transmit data using the HTTPS encrypted protocol.

Note that the server 92 and the kiosk 16 do not have to be in close proximity to one another. The server may be located in the “cloud”, that is, running in a cloud computing environment. The server may be a realized as a virtual server or as a physical server.

FIG. 15 schematically illustrates the major components of the server 92, whether a virtual server or a physical server. The server is a computer 94 that includes a processor 96, high speed memory 98 connected to the processor, non-volatile storage 100 which may one or more hard drives or solid-state drives (SSDs), and an input/output (I/O) port 102 that can provide wireless WIFI communications and optionally wired Ethernet connections. The I/O port is associated with a URL 103 assigned to the server for use in establishing the network connections 18a and 18b.

The server processor 96 runs software applications stored in the high speed memory 98. The software applications include the server operating system 104, and a server application 106. The server application 106 includes a web server application 106a and a web application 106b. The web server 106a processes incoming and outgoing HTTPS network communications. The web application 106b receives and transmits data through the server web server, and may also access the operating system.

The server 92 is typically used in a networked environment in which the server is connected by a computer network to a number of kiosks 16, and permits multiple users to simultaneously control respective kiosks on the network through the server. Accordingly, the web application 106b downloads the client application code to user mobile wireless devices and the kiosks do not. Furthermore, the server maintains kiosk data 108. The kiosk data includes the URL of each kiosk on the network, an id uniquely identifying each kiosk on the network and authentication data (passwords, tokens, or the like) to authenticate the server to a kiosk when connecting to the kiosk.

The web application 46b of the kiosk 16 shown in FIG. 14 also differs from the web application 46b in that the web application 46b is configured to connect only to the server 92 for remote control of the kiosk.

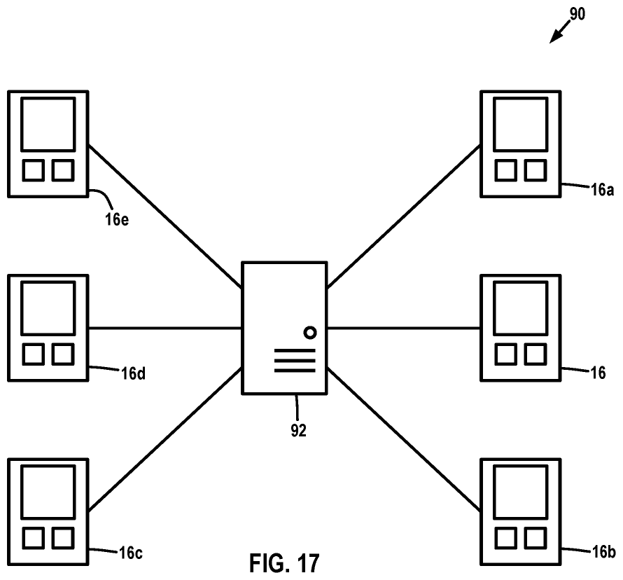

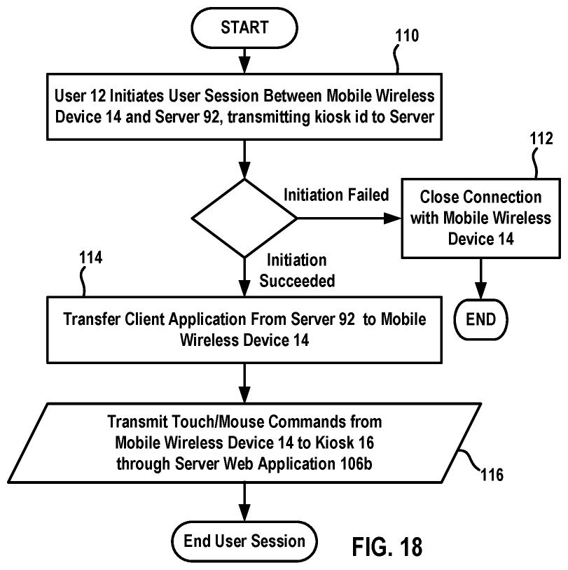

FIG. 17 illustrates a full second embodiment interactive kiosk system 90. The server 92 forms part of a local network configured for use in a restaurant, each kiosk 16, 16a, . . . 16e being located on a respective table of the restaurant and the server 14 being located in a secure location in the restaurant or in the cloud. The kiosks are used by restaurant customers to view the restaurant menu, order from the menu, and to pay their bills.

The server 92 and each kiosk 16, 16a, . . . 16e has its own unique network URL. The server kiosk data 108 includes a list of the kiosk network URLs.

FIG. 18 illustrates operation of the interactive kiosk system 90 in controlling the kiosk 16 from the user smartphone 14. In the first step 110, the user initiates a user session with the server 92 utilizing a wireless connection between the smartphone and the server spaced from the smartphone. Essentially initiating the user session includes the steps of connecting the smartphone to the server URL, and the user authenticating the connection.

The user connects the smartphone 14 to the server URL in substantially the same way the user connects the smartphone to the kiosk in the system 10: the user can scan a QR code on the kiosk, use NFC communications transmitted from the kiosk, or manually type the server URL shown on the kiosk in the smartphone web browser address bar.

However, the URL includes the URL of the server 92, and the URL includes a query string identifying the kiosk id that the user wishes to control.

The server 92 looks up the kiosk 16 in the kiosk data 110 using the kiosk id obtained from the query string. The server connects to the kiosk. In response, the kiosk remote control application 46 generates the authentication code 84 that is displayed on the kiosk touchscreen 34. The server application 106 then transmits the web form 86 to the user's web browser for the user to submit the authentication code back to the server for authentication. The server confirms the submitted authentication code with the kiosk.

If the connection is not authenticated, the network connection between the smartphone 14 and the kiosk 16 is closed, step 112.

If the connection is authenticated, the server 92 downloads the client application 88 to the smartphone 14 in step 114. The client application serializes the touch/mouse events in step 116 as previously described, and transmits the serialized touch/mouse events to the server 92 which in turn transmits the serialized events to the kiosk 16.

If the kiosk 16 is already connected to a user's mobile device through the server 92, the kiosk 16 can refuse additional connections from the server.

Because the server 92 may have simultaneous connections with multiple mobile wireless devices 14 and kiosks 16, 16a, . . . 16f, each connection 18a and 18b is provided with their own unique session ID generated by the server application 106 to associate the user's device and kiosk with the data transmitted to the server. For example, if the server application is written in PHP, the session start function may be used to generate the session ID. Use of sessions to identify network connections using the HTTPS protocol is conventional and so will not be described in further detail.

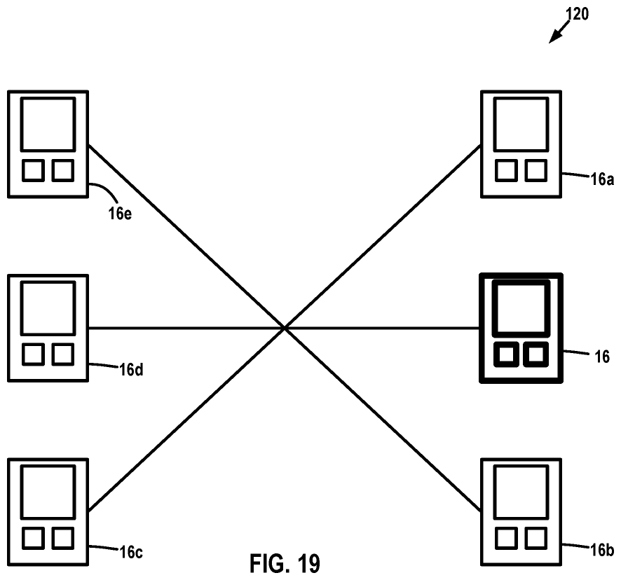

FIG. 19 illustrates a third embodiment interactive kiosk system 120 in accordance with this disclosure. The system 120 is similar to the system 90 except that the server 92 is eliminated and the kiosk 16 includes the server functionality for connecting the user to the other kiosks in the network. That is, when a user wishes to remotely operate the kiosk 16, the kiosk 16 operates identically as the kiosk 16 in FIG. 1 and connects directly with the user's mobile web device. When a user wishes to remotely operate one of the other kiosks 16a, . . . 16e, those kiosks provide the user with the URL of the kiosk 16 and the kiosk 16 functions identically as the server 92 in functioning as an intermediary server between the user's mobile device and the controlled kiosk.

Touch/mouse events as used herein include those generated on a touchscreen interface or the equivalent events generated through an audio interface.

The wireless connection between the mobile wireless device and a server or a kiosk means that the connection at the mobile wireless device is wireless, not that the entire connection between the mobile wireless device is made without wires. For example, the wireless connection of the mobile wireless device to the kiosk or server can be created by wireless connection of the mobile wireless device by WIFI to a router that itself is connected by an Ethernet cable to the server or kiosk. For another example, the mobile wireless device could wirelessly connect by a cellular network to a cell tower that in turn is connected to the server or kiosk by a connection that can include wired and/or wireless segments.

While this disclosure includes one or more illustrative embodiments described in detail, it is understood that the one or more embodiments are each capable of modification and that the scope of this disclosure is not limited to the precise details set forth herein but include such modifications that would be obvious to a person of ordinary skill in the relevant art including as well as such changes and alterations that fall within the purview of the following claims.

What is claimed is:

1. A method for operating an interactive kiosk system for remotely controlling a kiosk with a mobile wireless device spaced apart from the kiosk, the interactive kiosk system comprising at least one kiosk interconnected by a network to a server on the network, each of the at least one kiosks being associated with a unique id, and each of the at least one kiosks and the server being associated with a unique network URL,
the mobile wireless device being capable of sending and receiving wireless transmissions and comprising a touchscreen display capable of generating touch/mouse events in response to a user using the touchscreen display as an input device and a computer processor coupled to the memory to execute software applications stored in the memory;
the kiosk comprising a touchscreen display capable of generating touch/mouse events in response to a user using the touchscreen display as an input device, I/O being configured for communicating with the server through the network and a computer processor coupled to the memory to execute software applications stored in the memory;
the server comprising a computer processor coupled to a memory to run software applications stored in the memory and I/O being configured for communicating through the network with the kiosks and being configured for wireless communication with the mobile wireless device,
the method comprising the steps of:
(a) creating a wireless connection between the server and the mobile wireless device operated by a user of the mobile wireless device;
(b) transmitting the id of the kiosk to be controlled by the user from the mobile wireless device to the server;
(c) downloading client application computer code to the mobile wireless device for running a client application on the mobile wireless device;
(d) running the downloaded client application on the mobile wireless device, the client application displaying a user interface for controlling the kiosk via the touchscreen display of the mobile wireless device;
(e) generating touch/mouse event data representing touch/mouse events generated by use of the user interface by the user in controlling the kiosk through the user interface;
(f) wirelessly transmitting the touch/mouse event data from the mobile wireless device to the server and transmitting data representing the touch/mouse event data received from the mobile wireless device from the server to the kiosk; and
(g) executing touch/mouse events on the kiosk using the data transmitted to the kiosk from the server whereby the kiosk effectively operates as if the events were actually generated from the kiosk touchscreen display.

2. The method of claim 1 comprising the step of:
(h) authenticating the wireless connection between the server and the mobile wireless device.

3. The method of claim 2 wherein step (h) comprises the steps of:
(i) displaying an authentication code on the kiosk touchscreen display;
(j) the user transmitting the authentication code from the mobile wireless device to the server; and
(k) the server confirming the authentication code with the kiosk.

4. The method of claim 1 wherein step (a) comprises the steps of:
(h) the user obtaining the URL of the server; and
(i) connecting the mobile wireless device to the server at the URL of the server.

5. The method of claim 4 wherein step (h) comprises one of the following steps (j), (k), and (l):
(j) scanning a QR code encoding the URL using the mobile wireless device, the QR code being displayed on the kiosk touchscreen display;
(k) receiving wireless communications transmitting the URL from the kiosk to the mobile wireless device; and
(l) the user viewing the URL on the touchscreen display of the kiosk.

6. The method of claim 5 wherein:
step (h) consists of one of the steps (j) and (k); and
step (i) comprises automatically opening a web browser on the mobile wireless device after obtaining the server URL and connecting the opened web browser to the server.

7. The method of claim 1 wherein the client application runs in a web browser of the mobile wireless device.

8. The method of claim 1 wherein the client application code comprises Javascript code.

9. The method of claim 8 wherein the client application utilizes one or more event listeners that capture touch/mouse events generated on the mobile wireless device.

10. The method of claim 1 wherein the server comprises kiosk data storing the id and the URL of each kiosk on the network forming part of the interactive kiosk system.

11. The method of claim 1 wherein the mobile wireless device is a smartphone or a tablet.

12. The method of claim 1 wherein the server utilizes a first Session ID with the wireless communications between the server and the mobile wireless device and the server utilizes a second Session ID with communications between the server and the kiosk.

13. The method of claim 1 wherein the kiosk/server network is a wired network.

14. The method of claim 1 wherein the wireless communications between the server and the mobile wireless device uses the HTTPS protocol.

15. The method of claim 1 wherein the communications between the server and the one or more kiosks uses the HTTPS protocol.

16. The method of claim 1 wherein the at least one kiosk comprises two or more kiosks and the server is a web server, the web server permitting simultaneous connections of the server to multiple mobile wireless devices that remotely control respective kiosks through the server.

17. The method of claim 1 wherein the interactive kiosk system is configured for operation in a restaurant, each at least one kiosk being configured to display menu choices of the restaurant.

18. The method of claim 1 wherein each kiosk comprises a kiosk application, and a remote control application.

19. The method of claim 18 wherein the remote control application comprises a web server application and a web application.

20. The method of claim 19 wherein the web server application is communicably connected to the kiosk I/O and is configured to transfer data between the kiosk I/O and the web application.

21. The method of claim 1 comprising the step of:
(h) redirecting the mobile wireless device to a different URL after the user has controlled the kiosk through the mobile wireless device.
